(19) United States
(12) Patent Application Publication
(10) Pub. No.: US 2012/0268024 A1
(43) Pub. Date: Oct. 25, 2012

(54) CURRENT-SHARING BACKLIGHT DRIVING CIRCUIT FOR LIGHT-EMITTING DIODES AND METHOD FOR OPERATING THE SAME

(76) Inventors: Shih-Hsien CHANG, Taoyuan County (TW); Po-Nien KO, Taoyuan County (TW)

(21) Appl. No.: 13/156,615

(22) Filed: Jun. 9, 2011

(30) Foreign Application Priority Data
Apr. 21, 2011 (TW) 100113837

(51) Int. Cl. H05B 37/02

(52) U.S. Cl. 315/201

(57) ABSTRACT

A current-sharing backlight driving circuit for light-emitting diodes and a method for operating the same are disclosed. The current-sharing backlight driving circuit includes a class-E converter and a plurality of power processing units. The class-E converter receives a DC input voltage and produces an AC output voltage. The AC output voltage outputted from the class-E converter is converted into a DC driven voltage thorough the power processing units, thus driving the light-emitting diodes and providing a current-sharing backlight operation.

### BACKGROUND OF THE INVENTION

1. Field of the Invention

The present invention relates generally to a current-sharing backlight driving circuit and a method for operating the same, and more particularly to a current-sharing backlight driving circuit for light-emitting diodes and a method for operating the same.

2. Description of Prior Art

For many years, the light-emitting diodes (LEDs) play an important role in the backlight of portable electronic products. In the lighting application, LEDs are the most crucial components in the solid-state lighting industry. The advantages of LEDs include: energy saving, long life-span, free of maintenance, long life-span, and so on. In addition, a well-matched driving circuit for driving LEDs is very necessary in whether the lighting, the backlight, or the display fields. Especially to deserve to be mentioned, the backlight module is an important apparatus for the flat panel display. The backlight module determines the display quality of the flat panel display because of the reliability and stability of the LEDs.

However, the current flows through the LEDs of the LED lamp may not exactly identical due to somewhat different inner resistances of the LEDs when the LED lamp is driven through a voltage source. In addition, because the illuminating brightness of each LED is proportional to the forward current thereof, the above-mentioned problem would cause different illuminating brightness, thus overall efficiency of the LED lamp would decrease. Hence, in order to increase current balance capability between the LED lamps to improve the display quality of the flat panel display, various current-balancing circuits for LED lamps are to come with the tide of fashion.

Reference is made to FIG. 1 and FIG. 2 which are a schematic circuit diagram of a prior art half-bridge circuit and a prior art full-bridge circuit for driving a light-emitting diode, respectively. The half-bridge circuit (as shown in FIG. 1) and the full-bridge circuit (as shown in FIG. 2) are commonly used to generate the AC power source. Further, the generated AC power source can be used to provide the required power for driving the rear-stage current-sharing circuit.

However, the half-bridge circuit and the full-bridge circuit need to use two switches (namely, a first switch component Q11 and a second switch component Q12 shown in FIG. 1) and four switch components (namely, a first switch component Q21, a second switch component Q22, a third switch component Q23, and a fourth switch component Q24), respectively. Besides, at least one transformer (as a first transformer Tr1 shown in FIG. 1 and a second transformer Tr2 shown in FIG. 2 need to be associated to these switch components. Accordingly, this causes more costs for the half-bridge or full-bridge structure of the converter and causes less reliability problems.

Accordingly, it is desirable to provide a current-sharing backlight driving circuit for light-emitting diodes and a method for operating the same to produce an AC output voltage through a class-E converter and the AC output voltage is converted into the DC driven voltage through the power processing units, thus driving the light-emitting diodes and providing a current-sharing backlight operation.

### SUMMARY OF THE INVENTION

An object of the invention is to provide a current-sharing backlight driving circuit for light-emitting diodes to solve the above-mentioned problems.

The current-sharing backlight driving circuit for light-emitting diodes includes a class-E converter and a plurality of power processing units.

The class-E converter receives a DC input voltage and produces an AC output voltage. The class-E converter has a magnetic component and a power switch. The power switch is electrically connected to the magnetic component. The DC input voltage supplies energy to the magnetic component when the power switch is turned on and the magnetic component releases energy stored in the magnetic component when the power switch is turned off.

Each power processing unit has a balancing capacitor and a rectifying filtering unit. The balancing capacitor is electrically connected to the magnetic component, and the balancing capacitor is charged through the released energy provided by the magnetic component to provide a resonant operation. The rectifying filtering unit is electrically connected to the balancing capacitor and the corresponding light-emitting diode to rectify and filter the AC output voltage, thus producing a DC driven voltage to drive the corresponding light-emitting diode.

Another object of the invention is to provide a method for operating a current-sharing backlight driving circuit to solve the above-mentioned problems. The method for operating the current-sharing backlight driving circuit includes the steps as follows: First, a class-E converter is provided, and the class-E converter has a magnetic component and a power switch. Afterward, the class-E converter receives a DC input voltage and controls the magnetic component storing or releasing energy provided from the DC input voltage through the power switch, thus producing an AC output voltage. Afterward, a number of power processing units are provided, and each power processing unit has a balancing capacitor and a rectifying filtering unit. Afterward, the released energy is provided through the magnetic component to charge the balancing capacitors to provide a resonant operation. Finally, the rectifying filtering units are provided to rectify and filter the AC output voltage to produce a DC driven voltage, thus driving the corresponding light-emitting diode.

Therefore, the class-E converter is provided to produce the AC output voltage and the AC output voltage is converted into the DC driven voltage through the power processing units, thus driving the light-emitting diodes and providing a current-sharing backlight operation.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic circuit diagram of a prior art half-bridge circuit for driving a light-emitting diode;

FIG. 2 is a schematic circuit diagram of a prior art full-bridge circuit for driving a light-emitting diode;

FIG. 3a is a circuit diagram of a current-sharing backlight driving circuit for light-emitting diodes according to a first embodiment of the present invention;

FIG. 3b is a circuit diagram equivalent to the current-sharing backlight driving circuit shown in FIG. 3a;

FIG. 4a is a circuit diagram of the current-sharing backlight driving circuit for light-emitting diodes according to a second embodiment of the present invention;

FIG. 4b is a circuit diagram equivalent to the current-sharing backlight driving circuit shown in FIG. 4a;

FIG. 5 is a schematic curve chart of current and voltage with respect to the current-sharing backlight driving circuit of the present invention; and

FIG. 6 is a flowchart of a method for operating the current-sharing backlight driving circuit of the present invention.

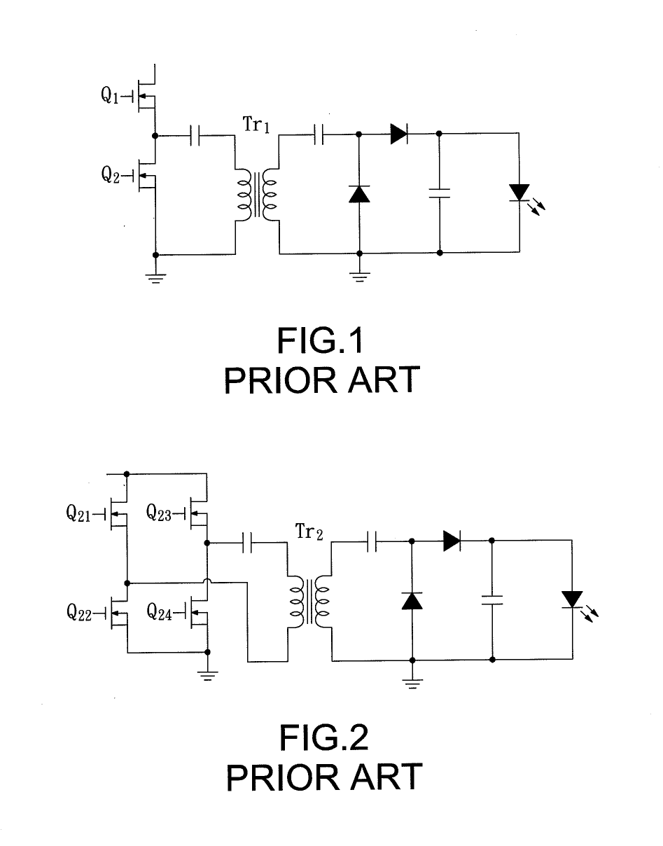

### DETAILED DESCRIPTION OF THE INVENTION

Reference will now be made to the drawing figures to describe the present invention in detail.

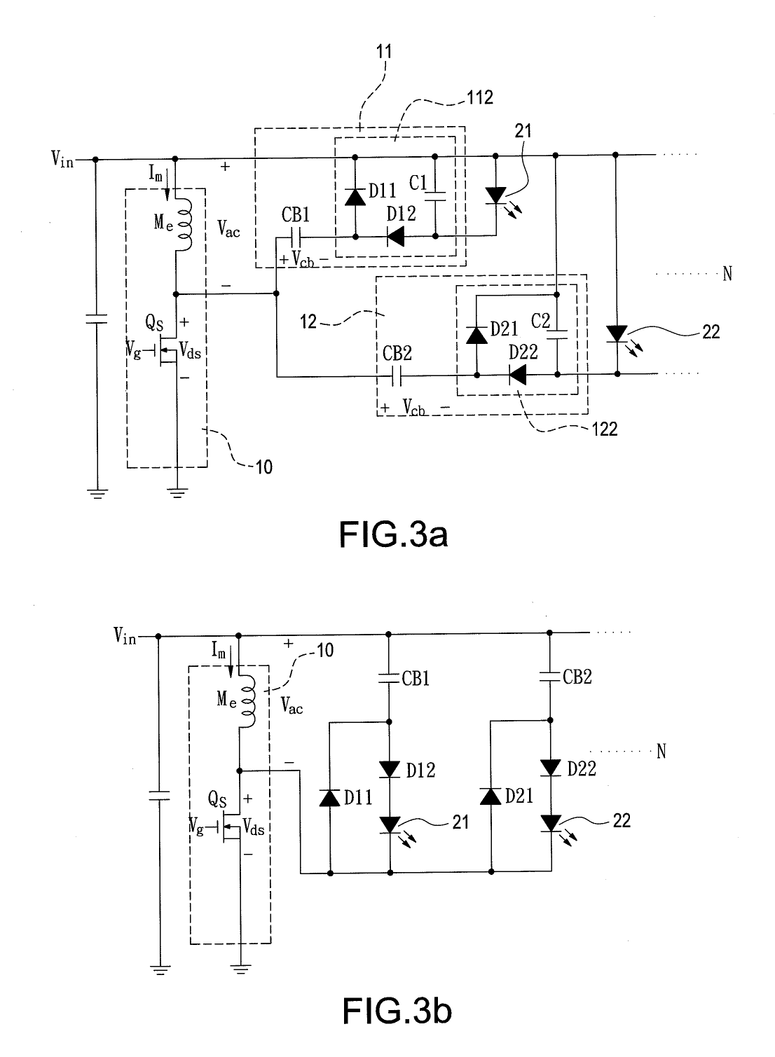

Reference is made to FIG. 3a which is a circuit diagram of a current-sharing backlight driving circuit for light-emitting diodes according to a first embodiment of the present invention. The current-sharing backlight driving circuit is provided to drive a plurality of light-emitting diodes. In this embodiment, the amount of the current-sharing backlight driving circuit is, but not limited to, two. That is, the current-sharing backlight driving circuit is provided to drive two light-emitting diodes, namely, a first light-emitting diode 21 and a second light-emitting diode 22, respectively. The current-sharing backlight driving circuit includes a class-E converter 10 and a plurality of power processing units. As mentioned above, the current-sharing backlight driving circuit includes two power processing units, namely, a first power processing unit 11 and a second power processing unit 12. The class-E converter 10 receives a DC input voltage Vin and produces an AC output voltage Vac. Also, the class-E converter 10 includes a magnetic component Me and a power switch Qs. In particular, the magnetic component Me can be an inductor or a transformer. The inductor is exemplified for further demonstration in this embodiment, whereas the transformer will be exemplified in another embodiment. In addition, the power switch Qs can be, but not limited to, a metal-oxide-semiconductor field-effect transistor, MOSFET. The power switch Qs is electrically connected to the inductor Me. The DC input voltage Vin supplies energy to the inductor Me when the power switch Qs is turned on and the inductor Me releases energy stored in the inductor Me when the power switch Qs is turned off.

Each power processing unit, namely, the first power processing unit 11 and the second power processing unit 12 has a balancing capacitor and a rectifying filtering unit, respectively. That is, the first power processing unit 11 has a first balancing capacitor CB1 and a first rectifying filtering unit 112; the second power processing unit 12 has a second balancing capacitor CB2 and a second rectifying filtering unit 122. In particular, the capacitance value of the first balancing capacitor CB1 is the same to that of the second balancing capacitor CB2. The first balancing capacitor CB1 is electrically connected to the inductor Me and the first balancing capacitor CB1 is charged through the released energy provided by the inductor Me. Similarly, the second balancing capacitor CB2 is electrically connected to the inductor Me and the second balancing capacitor CB2 is charged through the released energy provided by the inductor Me. An equivalent capacitance value, which is formed by the first balancing capacitor CB1 and the second balancing capacitor CB2, and the inductor Me are associated to occur an electrical resonance, thus producing a sinusoidal resonant voltage Vcb across the first balancing capacitor CB1 and the second balancing capacitor CB2, respectively. Accordingly, the electrical resonance can significantly eliminate switching losses of the power switch Qs and reduce electromagnetic interference (EMI) due to the di/dt and dv/dt, respectively.

The first rectifying filtering unit 112 and the second rectifying filtering unit 122 has two rectifying diodes and one filtering capacitor. That is, the first rectifying filtering unit 112 has a first filtering capacitor C1, a first rectifying diode D11, and a second rectifying diode D12. Also, the second rectifying filtering unit 122 has a second filtering capacitor C2, a third rectifying diode D21, and a fourth rectifying diode D22. The first rectifying filtering unit 112 is electrically connected to the first balancing capacitor CB1 and the second rectifying filtering unit 122 is electrically connected to the second balancing capacitor CB2 to rectify and filter the AC output voltage Vac, thus producing a DC driven voltage (not labeled) to drive the first light-emitting diode 21 and the second light-emitting diode 22, respectively. Therefore, the class-E converter 10 is provided to produce the AC output voltage Vac and the AC output voltage Vac is converted into the DC driven voltage through the first power processing unit 11 and the second power processing unit 12, thus driving the first light-emitting diode 21 and the second light-emitting diode 22 and providing a current-sharing backlight operation.

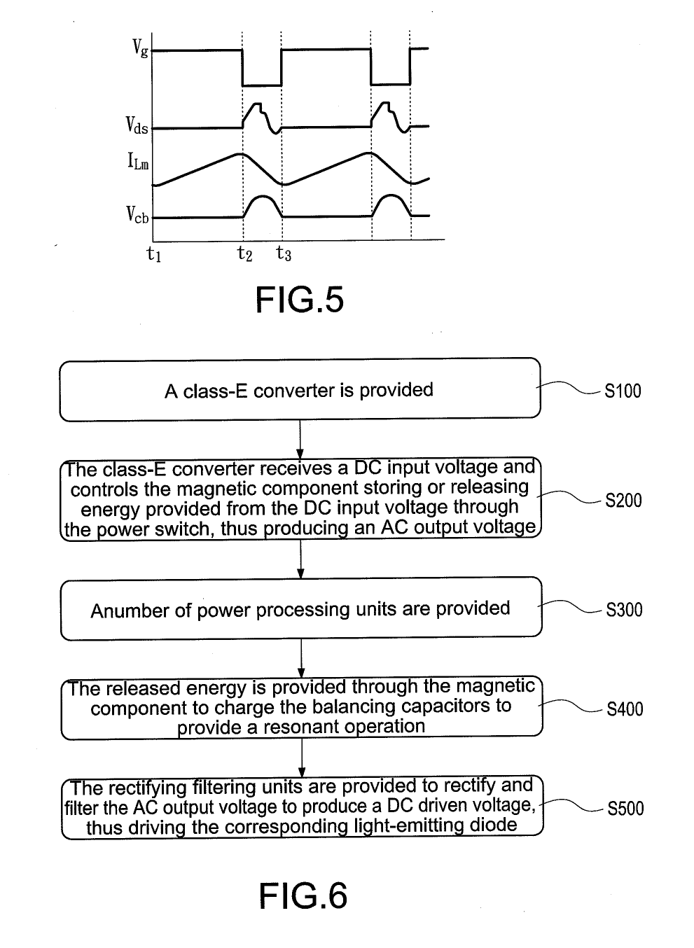

The detailed circuit structure and operation of the current-sharing backlight driving circuit can be described as follows, but it will be understood that the invention is not limited to the details thereof. Reference is made to FIG. 5 which is a schematic curve chart of current and voltage with respect to the current-sharing backlight driving circuit of the present invention. The curve chart of FIG. 5 shows, starting from the top, a control voltage Vg, a drain-source voltage Vds, a current Im, and a resonant voltage Vcb. In addition, the current-sharing backlight driving circuit further includes a controller (not shown) for controlling the power switch Qs to be turned on or turned off.

At a first time t1, the controller outputs a high-level control voltage Vg to turn on the power switch Qs. At this time, the current Im flowing through the magnetic component Me gradually increases linearly so that the DC input voltage Vin supplies energy to the magnetic component Me and the supplied energy is stored in the magnetic component Me. In this case, the drain-source current of the power switch Qs is produced. Accordingly, the current Im does not flow through the first power processing unit 11 and the second power processing unit 12 but the magnetic component Me and the power switch Qs.

Until a second time t2, the controller outputs a low-level control voltage Vg to turn off the power switch Qs. At this time, the drain-source voltage Vds of the power switch Qs increases so that the stored energy in the magnetic component Me is released through the first power processing unit 11 and the second power processing unit 12. Hence, the current Im flowing through the magnetic component Me gradually decreases. At the same time, an equivalent capacitance value, which is formed by the first balancing capacitor CB1 and the second balancing capacitor CB2, and the magnetic component Me are associated to occur an electrical resonance, thus producing a sinusoidal resonant voltage Vcb across the first balancing capacitor CB1 and the second balancing capacitor CB2, respectively. Hence, the magnetic component Me and the power switch Qs of the class-E converter 10 receives the DC input voltage Vin and produces the AC output voltage Vac for charging the first balancing capacitor CB1 and the second balancing capacitor CB2 and occurring the resonant operation through the magnetic component and the overall balancing capacitors. During a switch cycle of the power switch Qs, the outputted magnetizing energy is equal to Po=½×C×V̂ 2×f. In particular, the term Po is the outputted magnetizing energy, the term f is the switching frequency, the term C is the equivalent capacitance value, the term V is the resonant voltage magnitude, and the symbol ̂ represents a square operation. Afterward, a following switch cycle is executed, namely, the power switch Qs is turned on once again at a third time t3 when the stored energy in the magnetic component Me is completely released.

In addition, the first filtering capacitor C1, the first rectifying diode D11, and the second rectifying diode D12 of the first rectifying filtering unit 112 are used to rectify and filter the AC output voltage Vac to produce the DC driven voltage of driving the first light-emitting diode 21. Similarly, the second filtering capacitor C2, the third rectifying diode D21, and the fourth rectifying diode D22 of the second rectifying filtering unit 122 are used to rectify and filter the AC output voltage Vac to produce the DC driven voltage of driving the second light-emitting diode 22.

Reference is made to FIG. 3b which is a circuit diagram equivalent to the current-sharing backlight driving circuit shown in FIG. 3a. Because the impedance of the first balancing capacitor CB1 and the second balancing capacitor CB2 are much greater than the impedance of the first light-emitting diode 21 and the second light-emitting diode 22, the latter can be ignored. Accordingly, the current-sharing operation of the first light-emitting diode 21 and the second light-emitting diode 22 can be implemented by providing the same capacitance value of the first balancing capacitor CB1 and the second balancing capacitor CB2, thus increasing current balance capability, luminescence efficiency, and maintaining uniform backlight brightness.

Therefore, the class-E converter is provided to produce the AC output voltage Vac and the AC output voltage Vac is converted into the DC driven voltage through the first power processing unit 11 and the second power processing unit 12, thus driving the first light-emitting diode 21 and the second light-emitting diode 22 and providing a current-sharing backlight operation.

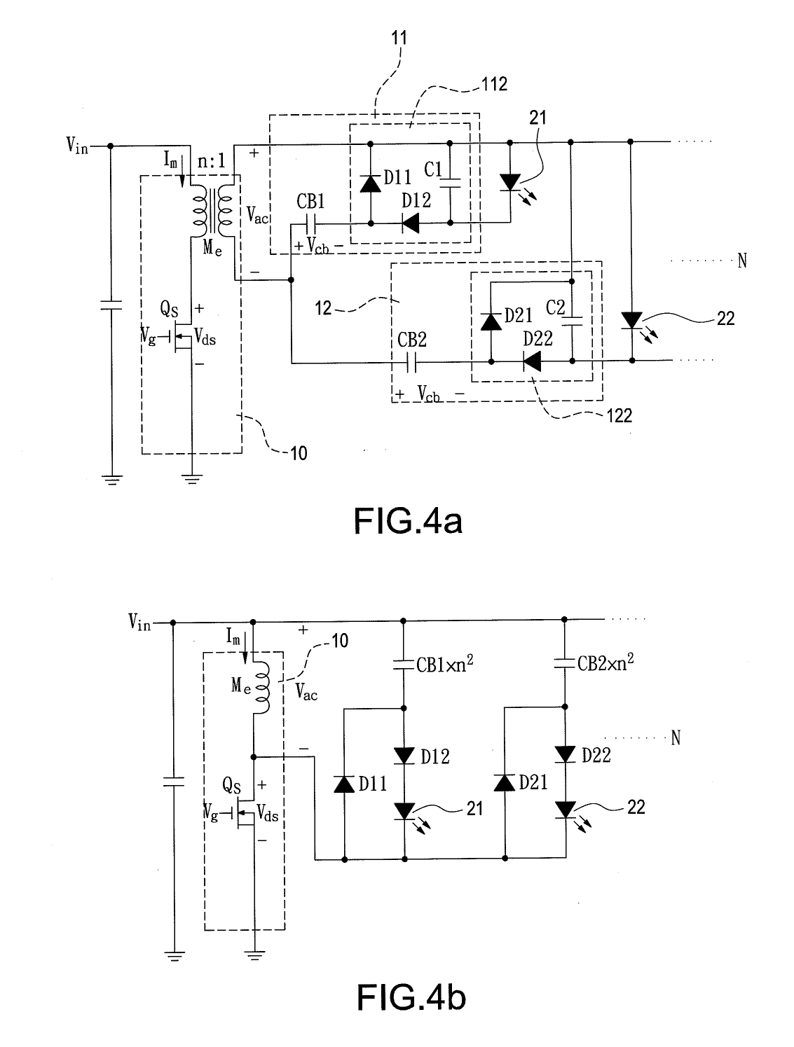

Reference is made to FIG. 4a which is a circuit diagram of the current-sharing backlight driving circuit for light-emitting diodes according to a second embodiment of the present invention. The major difference between the embodiment and the first embodiment is that the magnetic component Me in this embodiment is a transformer with turn ratio n:1. As mentioned above, the amount of the current-sharing backlight driving circuit is, but not limited to, two. That is, the current-sharing backlight driving circuit, which includes a first power processing unit 11 and a second power processing unit 12, is provided to drive a first light-emitting diode 21 and a second light-emitting diode 22.

The class-E converter 10 receives a DC input voltage Vin and process an AC output voltage Vac. Also, the class-E converter 10 includes the transformer Me and a power switch Qs. The power switch Qs is electrically connected to the transformer Me. The DC input voltage Vin supplies energy to the transformer Me when the power switch Qs is turned on and the transformer Me releases energy stored in the transformer Me when the power switch Qs is turned off.

The first power processing unit 11 and the second power processing unit 12 has a balancing capacitor and a rectifying filtering unit, respectively. That is, the first power processing unit 11 has a first balancing capacitor CB1 and a first rectifying filtering unit 112; the second power processing unit 12 has a second balancing capacitor CB2 and a second rectifying filtering unit 122. In particular, the capacitance value of the first balancing capacitor CB1 is the same to that of the second balancing capacitor CB2.

Reference is made to FIG. 4b which is a circuit diagram equivalent to the current-sharing backlight driving circuit shown in FIG. 4a. Because the turn ratio between a primary-side winding and a secondary-side winding of the transformer Me is n:1, the capacitance values of the first balancing capacitor CB1 and the second balancing capacitor CB2 can be converted into equivalent capacitance values in the primary-side winding by multiplying the square of the turn ratio (as shown in FIG. 4b). The first balancing capacitor CB1 is electrically connected to the transformer Me and the first balancing capacitor CB1 is charged through the released energy provided by the magnetic component. Similarly, the second balancing capacitor CB2 is electrically connected to the transformer Me and the second balancing capacitor CB2 is charged through the released energy provided by the transformer Me. An equivalent capacitance value, which is formed by the first balancing capacitor CB1 and the second balancing capacitor CB2, and the transformer Me are associated to occur an electrical resonance, thus producing a sinusoidal resonant voltage Vcb across the first balancing capacitor CB1 and the second balancing capacitor CB2, respectively. Accordingly, the electrical resonance can significantly eliminate switching losses of the power switch Qs and reduce electromagnetic interference (EMI) due to the di/dt and dv/dt, respectively.

Reference is made to FIG. 6 which is a flowchart of a method for operating the current-sharing backlight driving circuit of the present invention. The current-sharing backlight driving circuit is provided to drive a plurality of light-emitting diodes. The method for operating the current-sharing backlight driving circuit includes the steps as follows: First, a class-E converter is provided (S100). The class-E converter has a magnetic component and a power switch. Also, the magnetic component can be an inductor or a transformer, and the power switch can be, but not limited to, a metal-oxide-semiconductor field-effect transistor, MOSFET. In addition, the current-sharing backlight driving circuit further includes a controller for controlling the power switch to be turned on or turned off.

Afterward, the class-E converter receives a DC input voltage and controls the magnetic component storing or releasing energy provided from the DC input voltage through the power switch, thus producing an AC output voltage (S200). The class-E converter receives the DC input voltage and produces the AC output voltage. When the power switch is turned on, a current flowing through the magnetic component gradually increases linearly so that the DC input voltage supplies energy to the magnetic component and the supplied energy is stored in the magnetic component. On the other hand, the magnetic component releases energy stored in the magnetic component when the power switch is turned off.

Afterward, a number of power processing units are provided (S300). In particular, each power processing unit has a balancing capacitor and a rectifying filtering unit. Also, each rectifying filtering unit has two rectifying diodes and one filtering capacitor. Also, each balancing capacitor has the same capacitance value.

Afterward, the released energy is provided through the magnetic component to charge the balancing capacitors to provide a resonant operation (S400). An equivalent capacitance value, which is formed by the balancing capacitors, and the magnetic component are associated to occur an electrical resonance, thus producing a sinusoidal resonant voltage across each balancing capacitor. Hence, the magnetic component and the power switch of the class-E converter receives the DC input voltage and produces the AC output voltage for charging the balancing capacitors and occurring the resonant operation through the magnetic component and the overall balancing capacitors. Accordingly, the electrical resonance can significantly eliminate switching losses of the power switch and reduce electromagnetic interference (EMI) due to the di/dt and dv/dt, respectively.

Finally, the rectifying filtering units are provided to rectify and filter the AC output voltage to produce a DC driven voltage, thus driving the corresponding light-emitting diode (S500). The rectifying diodes and the filtering capacitor of the rectifying filtering unit are used to rectify and filter the AC output voltage to produce the DC driven voltage of driving the light-emitting diodes.

Therefore, the class-E converter is provided to produce the AC output voltage and the AC output voltage is converted into the DC driven voltage through the power processing units, thus driving the light-emitting diodes and providing a current-sharing backlight operation.

In conclusion, the present invention has following advantages:

1. Only one power switch and one magnetic component are used to produce an AC power source to provide the required power for driving the rear-stage current-sharing circuit, thus increasing current balance capability, luminescence efficiency, and maintaining uniform backlight brightness; and

2. Only one power switch and one magnetic component are used to reduce component costs and increase reliability of the current-sharing backlight driving circuit.

Although the present invention has been described with reference to the preferred embodiment thereof, it will be understood that the invention is not limited to the details thereof

Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A current-sharing backlight driving circuit for light-emitting diodes, comprising:
a class-E converter receiving a DC input voltage and producing an AC output voltage, the class-E converter comprising:
a magnetic component; and
a power switch electrically connected to the magnetic component, wherein the DC input voltage supplies energy to the magnetic component when the power switch is turned on, and the magnetic component releases energy stored in the magnetic component when the power switch is turned off; and
a plurality of power processing units, each power processing unit comprising:
a balancing capacitor electrically connected to the magnetic component, and the balancing capacitor charged through the released energy provided by the magnetic component to provide a resonant operation; and
a rectifying filtering unit electrically connected to the balancing capacitor and the corresponding light-emitting diode to rectify and filter the AC output voltage, thus producing a DC driven voltage to drive the corresponding light-emitting diode.

2. The current-sharing backlight driving circuit of claim 1, further comprising a controller for controlling the power switch to be turned on or turned off.

3. The current-sharing backlight driving circuit of claim 1, wherein the magnetic component is an inductor.

4. The current-sharing backlight driving circuit of claim 1, wherein the magnetic component is a transformer.

5. The current-sharing backlight driving circuit of claim 1, wherein the power switch is a metal-oxide-semiconductor field-effect transistor (MOSFET).

6. The current-sharing backlight driving circuit of claim 1, wherein the rectifying filtering unit comprises a first rectifying diode, a second rectifying diode, and a filtering capacitor.

7. The current-sharing backlight driving circuit of claim 1, wherein the balancing capacitors have the same capacitance value.

8. The current-sharing backlight driving circuit of claim 1, wherein the magnetic component and the overall balancing capacitors provide the resonant operation.

9. A method for operating a current-sharing backlight driving circuit; steps of the method comprising:
(a) providing a class-E converter having a magnetic component and a power switch;
(b) receiving a DC input voltage through the class-E converter and controlling the magnetic component storing or releasing energy provided from the DC input voltage through the power switch;
(c) providing a plurality of power processing units, and each power processing unit having a balancing capacitor and a rectifying filtering unit;
(d) providing the released energy through the magnetic component to charge the balancing capacitors to provide a resonant operation; and
(e) rectifying and filtering the AC output voltage through the rectifying filtering unit to produce a DC driven voltage, thus driving the corresponding light-emitting diode;
whereby the class-E converter is provided to produce the AC output voltage and the AC output voltage is converted into the DC driven voltage through the power processing units, thus driving the light-emitting diodes and providing a current-sharing backlight operation.

10. The method for operating the current-sharing backlight driving circuit of claim 9, in the step (b), the DC input voltage supplies energy to the magnetic component when the power switch is turned on and the magnetic component releases energy stored in the magnetic component when the power switch is turned off.

11. The method for operating the current-sharing backlight driving circuit of claim 9, wherein the current-sharing backlight driving circuit further comprises a controller for controlling the power switch to be turned on or turned off.

12. The method for operating the current-sharing backlight driving circuit of claim 9, wherein the magnetic component is an inductor.

13. The method for operating the current-sharing backlight driving circuit of claim 9, wherein the magnetic component is a transformer.

14. The method for operating the current-sharing backlight driving circuit of claim 9, wherein the power switch is a metal-oxide-semiconductor field-effect transistor (MOSFET).

15. The method for operating the current-sharing backlight driving circuit of claim 9, wherein the rectifying filtering unit comprises a first rectifying diode, a second rectifying diode and, a filtering capacitor.

16. The method for operating the current-sharing backlight driving circuit of claim 9, wherein the balancing capacitors have the same capacitance value.

17. The method for operating the current-sharing backlight driving circuit of claim 9, wherein the magnetic component and the overall balancing capacitors provide the resonant operation.
